(19) United States
(12) Patent Application Publication
(10) Pub. No.: US 2004/0100902 A1
(43) Pub. Date: May 27, 2004

(54) Gas treatment apparatus and method

(76) Inventors: Pannalal Vimalchand, Birmingham, AL (US); Guohai Liu, Birmingham, AL (US)

Correspondence Address: NEEDLE & ROSENBERG, P.C., SUITE 1000, 999 PEACHTREE STREET, ATLANTA, GA, 30309-3915, US

(21) Appl. No.: 10/305,795

(22) Filed: Nov. 27, 2002

(51) Int. Cl. H04L 12/28

(52) U.S. Cl. 370/230

(57) ABSTRACT

Devices and methods for treating a gas flow are disclosed. The gas treatment device includes a vessel into which a gas riser is passed. A gas chamber is defined within the vessel in communication with the gas riser and a treatment particle bed is extended at least partially about the gas riser. A flow control device in communication with the treatment particle bed and the gas riser is constructed and arranged to selectively pass gas treatment particles from the treatment particle bed into the gas riser such that the gas treatment particles become entrained and mixed with the gas flow within the riser. A first and a spaced second baffle may be positioned in the gas chamber and used to direct the gas flow passed into the gas chamber. The gas treatment methods include selectively passing at least some of the treatment particles into the gas flow so that the treatment particles become entrained with the gas to effect either or both of the thermal regulation and decontamination of the gas. At least one aeration nozzle is placed in communication with the flow control device, and a supply of a pressurized fluid is selectively passed therethrough to fluidize the gas treatment particles within the flow control device.

### FIELD OF THE INVENTION

The invention relates in general to process gas treatment devices and methods. More particularly, the present invention relates to improved devices and methods for treating a flow of a process gas with a plurality of gas treatment particles which are selectively passed from a particle bed through a flow control device and into the gas flow in order to become entrained therewith.

### BACKGROUND OF THE INVENTION

In advanced coal gasification processes, processed fuel gases, also called syngases, are generated from gases released from coal volatiles, partial combustion of coal and other carbonaceous materials and gas-solid reactions. Cooling and decontamination of the syngases prior to introduction into a combustor or chemical reactor is desirable as the gases are typically produced at sufficiently high temperatures that direct contact with a cooling device or cooling surface, for example a heat exchanger, oftentimes results in the erosion of such a surface or cooling device. Moreover, the contaminants present within the processed fuel gas or syngas may also cause the fouling or corrosion of any cooling device or surface with which the gases come in contact.

It is known in the art to introduce particles into a gas flow for the purpose of cooling the gas prior to any desired downstream uses of the gas. One example of this known type of cooling device is illustrated in U.S. Pat. No. 5,505,907 to Hiltunen et al., which discloses an apparatus used for treating a hot gas flow by introducing cooling solids into the gas flow. The gas is cooled by the solids and thereafter exits through a gas port provided in the top of the device. The cooling solids settle into particle beds in which heat exchangers are provided for cooling the collected particles.

Another example of a cooling device is illustrated in U.S. Pat. No. 5,759,495 to Hyppänen. A circulating fluidized bed reactor is shown in FIG. 1 of the '495 patent, in which a hot process gas enters a mixing chamber and is mixed with a downwardly directed flow of solids which absorb thermal energy from the gas. The gas-particle mixture then enters a particle separator and the treated gas exits the reactor through an outlet and the separated solids fall back through a return duct into a storage bed of particles, in which a particle cooling heat exchanger is provided, for being reintroduced into the gas flow entering the reactor.

Although devices such as these have proven useful in cooling gas flows, there are problems in the ability to control the passage of the particles from the particle beds into the gas stream or flow in the desired particle amounts, when and as desired, and in providing a sufficient dwell time within the particle bed to allow the recycling particles to be adequately cooled.

What is needed, therefore, but unavailable in the art, are improved gas treatment devices and methods for treating process gases, as desired. In particular, there is a need for improved gas treatment devices and methods that will provide for the cooling and decontamination of syngases while also allowing a more precise control of the gas cooling and cleansing process.

### SUMMARY OF THE INVENTION

The present invention provides a gas treatment device, and methods, for selectively treating gas flows which overcome some of the design deficiencies of the known art.

In a first embodiment, the invention provides a gas treatment device which comprises a vessel formed about a longitudinal axis and having a first end and a spaced second end with a continuous sidewall extending therebetween. A gas chamber is defined within the vessel, and is in communication with an elongate gas riser passed into the vessel. A treatment particle bed is defined within the vessel with respect to the gas riser, and is placed in communication with the gas chamber. A flow control device is also provided which is in communication with each of the treatment particle bed and the gas riser. A treated gas discharge port is defined in the vessel sidewall and is in communication with the gas chamber so that the treated gases may pass therefrom.

The device further comprises a supply of gas treatment particles positioned within the treatment particle bed. The flow control device is constructed and arranged to selectively pass at least some of the supply of gas treatment particles from the treatment particle bed into the gas riser whereupon the gas treatment particles become entrained and mixed with the gas flow passing therethrough toward the gas chamber. As the gas flow and entrained treatment particles are passed from the gas riser into the gas chamber, the gas treatment particles fall out of the gas flow and into the treatment particle bed as the gas chamber is adapted to allow for a separation of the gas treatment particles from the gas flow such that the gas treatment particles are passed, or fall into the treatment particle bed. The direct contact of the gas flow with the treatment particles effects treatment of the gas to include either or both of the thermal regulation and decontamination of the gas flow, as desired.

At least one cooling device, for example a closed loop circulating water filled cooling pipe, is disposed within the treatment particle bed and used to cool the articles therein, as desired.

The flow control device comprises a flow control valve constructed and arranged to receive gas treatment particles from the treatment particle bed and to selectively fluidize at least a portion of the gas treatment particles so received in order to pass the particles into the gas riser. Accordingly, the flow control valve has at least one aeration nozzle in communication with a valve housing for passing a pressurized fluid into the valve housing to selectively fluidize at least a portion of the gas treatment particles held therein, and a supply of a pressurized fluid in communication with the at least one aeration nozzle for fluidizing the gas treatment particles.

In a second embodiment, the gas treatment device again comprises the elements of the first embodiment of the device described above with the addition of a first baffle positioned with respect to the gas riser and being constructed and arranged to receive and deflect the gas flow. The baffle has an elongate sidewall extending from along the peripheral surface of a planar surface and is thus formed as a concave vessel disposed across the axis of the gas riser such that the effluence of the riser is guided outwardly from the axis of the riser and then down toward the particle bed so that the particles entrained in the gas flow are separated from the flow and fall by gravity into the particle bed.

Additionally, a second baffle may be disposed within the gas chamber, the second baffle also comprising a planar or an arcuate surface placed substantially across the axis of the gas riser, and spaced above the first baffle with an elongate sidewall extending about and beyond the sidewall of the first baffle and into the particle bed, and preferably below the top surface of the particle bed. The sidewall of the second baffle has a series of radially spaced gas outlets defined therein such that a serpentine and tangential path, through which the gas flow passes, is defined within the gas chamber by the first baffle, the top surface of the particle bed, and the second baffle. A channel is defined between the sidewall of the second baffle and the vessel sidewall to provide for the return, by the force of gravity, of any further particles separated from the treated gas flow.

A method of treating a gas flow using the above-described gas treatment devices is also disclosed, the method comprising passing the gas flow to be treated through the gas riser and into the vessel, using the flow control device to selectively pass at least some of the supply of the gas treatment particles from the treatment particle bed into the gas riser such that the gas treatment particles passed into the gas riser are entrained and mixed with the gas flow, and treating the gas flow with the gas treatment particles. Thereafter, the gas flow and the entrained gas treatment particles are passed into the gas chamber, the method further comprising the steps of separating the entrained gas treatment particles from the gas flow in the gas chamber such that the gas treatment particles fall out of the gas flow, passing the treated gas flow from the vessel through the gas discharge port, and collecting in the treatment particle bed the gas treatment particles that have fallen out of the gas flow.

It is, therefore, an object of the invention to provide improved gas treatment devices and methods.

### BRIEF DESCRIPTION OF THE DRAWINGS

FIG. 1 is a schematic illustration of a first embodiment of a gas treatment device of the invention.

FIG. 2 is a schematic illustration of a flow control device for use with the gas treatment device of FIG. 1.

FIG. 3 is a schematic illustration of the flow control device of FIG. 2 with a gas seal formed by treatment particles held within the flow control device.

FIG. 4 is a front perspective view of the valve housing of the flow control device FIG. 2.

FIG. 5 is a rear perspective view of the valve housing of FIG. 4.

FIG. 6 is a schematic illustration of a second embodiment of a gas treatment device of the invention.

### DETAILED DESCRIPTION OF THE INVENTION

The present invention is more particularly described in the following examples that are intended as illustrative only since numerous modifications and variations therein will be apparent to those skilled in the art. As used in the specification and in the claims, “a,” “an,” and “the” may each mean one or more, depending upon the context in which it is used.

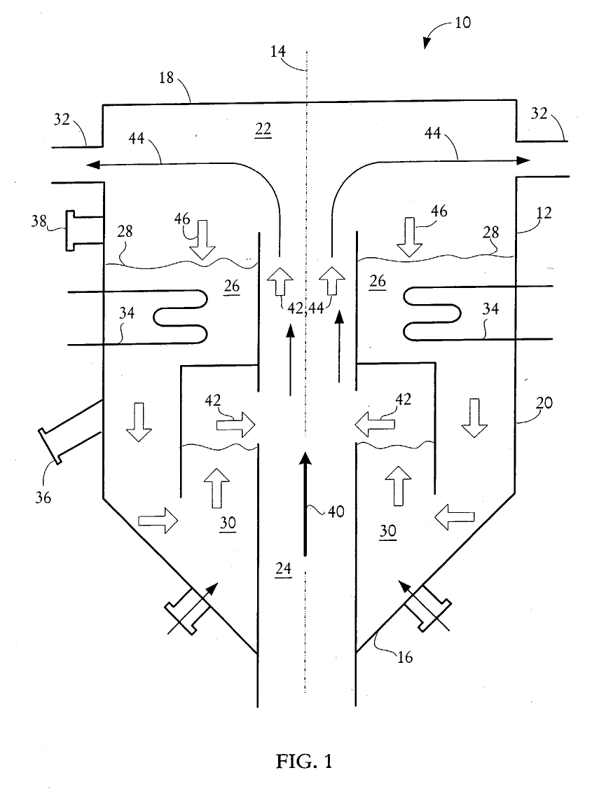

Referring now in detail to the drawings, in which like reference characters indicate like parts throughout the several views, a first embodiment of a gas treatment device 10 is illustrated in FIG. 1. The device includes an elongate vessel 12 formed about a longitudinal axis 14, the vessel being constructed in known fashion for accommodating the passage of a pressurized fluid, here a gas, therethrough. The vessel has a first end 16, a spaced second end 18, and a continuous sidewall 20 extending therebetween and joined to one another along their common side edges to define the vessel. A gas chamber 22 is defined within the vessel, and is positioned with respect to an elongate gas riser 24 extending through the vessel sidewall, the gas riser being in fluid communication with the gas chamber. The gas or gases to be treated are passed into the vessel through the gas riser and then into the gas chamber.

A treatment particle bed 26 is formed by the vessel sidewall and the gas riser such that the bed extends at least partially about the gas riser. An open top surface of the particle bed is in communication with the gas chamber. A supply of gas treatment particles 28 is held or stored within the particle bed when the device is prepared for usage, or is in use. A flow control device 30 adapted for the selective passage therethrough of at least some of the particles 28 is positioned within the vessel intermediate the particle bed and the gas riser, the flow control device being in fluid communication with each of the particle bed and the gas riser. At least one treated-gas discharge port 32 for the passage therethrough of treated gas to be exhausted from the vessel is defined within the vessel sidewall, and is also in fluid communication with the gas chamber.

A cooling device 34 is positioned within the particle bed for the purpose of cooling the supply of particles held therein. The treatment particles are progressively passed over, or drawn by the cooling device as additional particles in the treatment bed are passed into the gas riser and the gas flow passing therethrough, as described in greater detail below. The cooling device may comprise, for example one or more tubes for passage therethrough of a coolant and will preferably be constructed as a closed loop arrangement for recycling of the coolant, as known. Although not illustrated, the cooling device, or devices, will be supplied with a suitable coolant passed therethrough, for example water, by a conventional pump and piping arrangement. The cooling device may be in communication with an external heat exchange system (not illustrated) for the recovery and utilization, or disposal, of thermal energy collected from the supply of particles as they are cooled prior to re-use. The cooling device may be submerged within the treatment particle supply and thus direct contact of the hot gas flow with the cooling device may be avoided. Such an arrangement may thus minimize corrosion, erosion, and fouling of the cooling device.

A solids discharge port 36 is defined within the vessel sidewall, and is in communication with the particle bed. The discharge port is used for the discharge of particles that are spent, contaminated, or otherwise intended for removal from the vessel. A separate solids charge port 38 may also be provided for the loading and/or replenishing of particles into the particle bed.

In use, an upward flow 40 of the gas to be treated is passed into the vessel through the gas riser 24. The flow control device 30 is constructed to selectively pass a flow 42 of gas treatment particles from the supply of particles into the gas riser wherein the particles become entrained and mixed with the gas flow passing through the riser. The gas flow through the riser is maintained at a sufficiently high velocity to carry therewith and against the force of gravity the particle flow 42 passed into the riser by the flow control device. Within the riser the direct mixing of the particles with the gas flow provides for the efficient and rapid treatment of the gas flow, for example the transfer of thermal energy from the gas flow to the entrained particles, and/or the removal of contaminants therefrom, dependent upon the composition and construction of the gas treatment particles, which particles compositions and constructions are known to those skilled in the art.

The gas flow and entrained particles pass from the relatively narrow gas riser into the comparatively wider gas chamber wherein the velocity of the gas flow is reduced sufficiently to allow the particles to be separated from the gas by the force of gravity. The gas flow 40 thereby separated from the heated particles passes from the vessel through the discharge port(s) 32 as a flow of treated gas 44. Small particles, for example those with diameters of less than 30 micrometers, may escape separation from the gas flow within the gas chamber and be carried out of the vessel with the gas flow. A particle filter (not illustrated) may thus be provided in communication with the discharge port so that any such small particles may be removed from the flow of treated gas. Depending on application, a portion of particles captured in the filter may by recycled to the bed 26 through the port 38.

The treatment particles are generally separated from the gas flow above the particle bed 26 such that falling particles 46 collect therein to replenish the supply of particles. Thermal energy collected by the particles while entrained by the gas flow within the gas riser is thereby delivered to the supply of treatment particles within the treatment particle bed 26. The collected thermal energy may be discharged from the gas treatment device by the contact of the heated particles with the one or more cooling devices 34 disposed within the bed, as described above.

In a first aspect, the gas treatment device can be used to thermally treat, i.e., cool, the gas flow. For example, a hot gas flow such as a syngas flow from a fluidized bed gasifier or an entrained flow gasifier may be cooled by the device. Such a syngas flow would likely pass into the gas riser with a high temperature and be cooled therein before being passed into a downstream syngas combustor or chemical reactor, for example the combustor before the gas turbine of a power plant. Accordingly, the temperature of the syngas entering the gas riser may be in the range of from 1500 to 2700 degrees Fahrenheit, as listed in Tables I and II, below.

The gas treatment device may be also used in other applications where dust-laden, high-temperature gases are to be cooled. The velocity of the hot gases entering the gas riser into which the treatment particles are passed and entrained may, for example, be in the range of from 25 to 50 feet per second. Equilibration of the gas and entrained particle temperatures, respectively, occurs as the gas and particles flow together within the riser and may be reached within a few feet of the point of mixing. The degree of cooling of the gas flow and thereby the temperature of the flow of treated gas 44 passing out of the vessel through the gas discharge port may therefore be controlled by the control of the solids recirculation rate as effected by the flow control device, discussed in greater detail, below.

In a second aspect, the gas treatment device may be used to decontaminate the gas flow. For example, sulfur compounds such as hydrogen sulfide (H₂S) and carbonyl sulfide (COS) may be removed from the gas flow to minimize or prevent pollution in power generation and the poisoning of catalysts in chemical reactors. Vaporous contaminants may condense onto the particles as the gas is cooled within the riser. Tar and molten fly ash particles may solidify and become non-sticky, adhering to or being sorbed by the gas treatment particles. Trace contaminants such as mercury, lead, and cadmium may be removed from the gas flow by chemical or physical absorption or adsorption. Appropriate chemical sorbents may be provided with the particles or therein or thereon to facilitate decontamination of the gas, as desired.

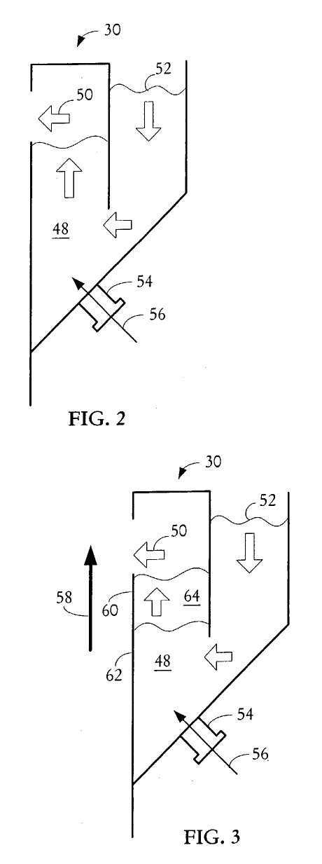

Referring now to FIGS. 2 and 3, an exemplary flow control device 30 is illustrated, The flow control device comprises, in one embodiment, a flow control valve 48 constructed and arranged to receive treatment particles therein from the particle bed 26 (FIG. 1), and to selectively fluidize at least a portion of the particles held therein so that a particle flow 50 occurs. Once selectively fluidized, the treatment particles may then be selectively passed from the flow control device and into the gas riser, for example as the particle flow 42 of FIG. 1. The treatment particles will be passed or fed into the flow control device from a reservoir 52 of treatment particles, for example the supply of treatment particles 28 (FIG. 1), through the force of gravity.

The flow control valve will be provided with one or more fluidization nozzles 54 used to pass a flow 56 of a pressurized fluid, for example nitrogen and steam, into the flow control valve to selectively fluidize at least a portion of the treatment particles within the valve. A conventional pressurized-fluid delivery system (not illustrated) may thus include any number of suitable components such as pumps and control valves used to provide a suitable flow of a pressurized fluid to the one or more nozzles 54.

Referring now to FIG. 3, the flow control valve 48 is constructed and arranged to provide for the passage of treatment particles therethrough and into a fluid stream 58, for example the gas flow 40 of FIG. 1, while preventing a backward flow of the fluid stream or any considerable portion thereof from passing in a reverse sense through the valve. An upper section 60 of the valve is formed to have a larger cross sectional area than a spaced lower section 62 to provide that the upper and lower sections, respectively, have different fluid velocities therein. The fluid introduced by the nozzle 54 into the lower section of the valve may have a sufficient velocity to fluidize and induce the treatment particles held therein to move the particles upwardly within the valve and therethrough while the relatively lower gas velocity within the upper section of the valve may be below a minimum particle-fluidization velocity. The non-fluidized portion of the upwardly-moving particle bed within the valve, if so formed, may act as a seal 64 to prevent the fluid stream 58 (gas flow) from flowing through the valve and into the treatment particle reservoir in a direction opposite that indicated by the arrows in FIG. 3.

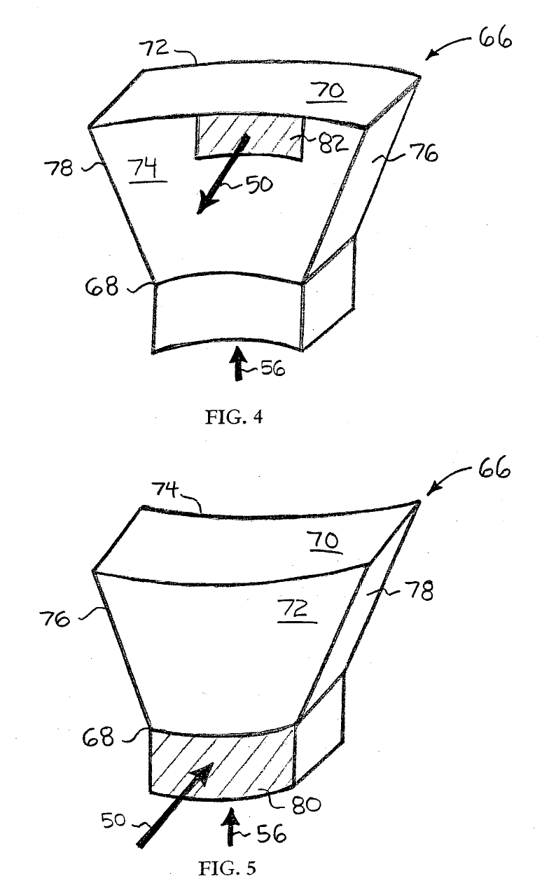

Referring now to FIGS. 4 and 5, the flow control valve 48 (FIG. 3) is illustrated. The valve comprises a valve housing 66 having a first end 68 and a spaced second end 70, a first side wall 72 with a corresponding spaced second side wall 74, and a third side wall 76 with a corresponding spaced fourth side wall 78, the respective side walls being joined to one another along their common edges and extending between the respective first and second ends of the valve housing. As illustrated, the first and second side walls are at least partially tapered outwardly away from one another as they extend from the first end toward the second end of the valve housing. An entry port 80 (FIG. 5) and an exit port 82 (FIG. 4) are defined at the first end 68 and the second end 70 of the valve housing, respectively, for allowing the passage of the particle flow 50 therethrough.

The valve housing is constructed and arranged so that the treatment particles passed into the entry port flow within the valve housing to the exit port when the fluidization nozzle 54 (FIG. 2) passes a flow 56 of pressurized fluid into the flow control valve and valve housing. The current of the flow 56 controls the rate of passage of the particles through the valve housing and the flow control valve 48 (FIG. 3), and is itself controlled by the degree of particle fluidization within the valve housing.

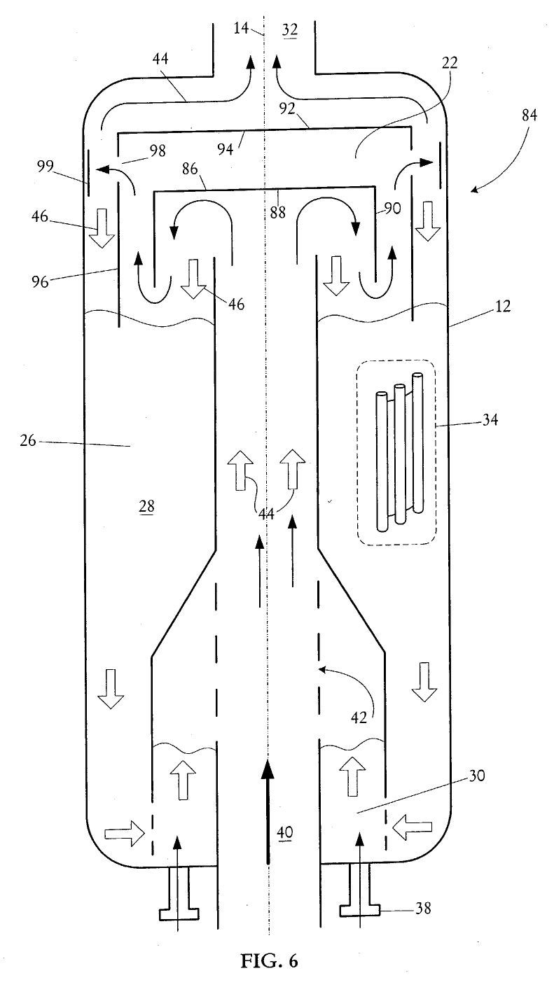

A second embodiment of a gas treatment device 84 is illustrated in FIG. 6. The gas treatment device 84 comprises all of the elements of the device 10 (FIG. 1), these common elements being numbered identically as those for the device 10, each such common element having a similar construction with a similar function as those detailed above with reference to FIGS. 1 through 5. Unlike the device 10, the gas treatment device 84 further comprises a first baffle 86 constructed and arranged with a planar or arcuate impact surface 88 positioned within the gas chamber 22 and extended substantially across the longitudinal axis 14 of the gas riser 24. The first baffle deflects the gas-flow 40 and the gas treatment particles entrained therewith as the gas flows along the axis 14.

The first baffle may optionally include an elongate sidewall 90 contiguous with and extended from the impact surface such that the first baffle is formed as a concave vessel disposed across the axis 14 and opening toward the gas riser such that the effluence of the gas riser is guided outwardly from the axis 14 and then down toward the particle bed 26 so that at least a portion of the treatment particles entrained with the flow of gas are separated from the gas flow and fall by gravity into the particle bed.

The gas treatment device 84 also includes a second baffle 92 positioned within the gas chamber 22 and spaced from the first baffle 86. The second baffle comprises a planar or arcuate surface 94 disposed within the gas chamber and extended substantially across the axis 14 of the gas riser 24, and has an elongate sidewall 96 contiguous with and extended from the surface 94 so that the second baffle is formed as a concave vessel disposed across the axis 14 and about the first baffle. The sidewall 96 of the second baffle is shown extending in the lengthwise direction beyond the sidewall 90 of the first baffle and into the treatment particle bed 26, and preferably below the top surface thereof.

Defined within the sidewall 96 is at least one tangential gas outlet 98, and preferably a plurality the gas outlets 98 are provided and are spaced radially about the longitudinal axis 14 of the vessel. The gas outlets 98 are used in concert with the first and second baffles, and their respective sidewalls to define a serpentine gas flow path through which the gas flow and treatment particles are passed. One or more impact plates 99 may be provided on the vessel sidewall, or otherwise positioned with respect to the outlets 98, to receive and deflect the gas flow to protect the sidewall 20 of the vessel. A channel may thus be defined between the sidewall 96 and the vessel sidewall 20 to provide for the return, by the force of gravity, of any additional particles separated from the flow of the treated gas by the impact plates.

The gas outlets 98 and the corresponding impact plates 99 may be defined and formed, respectively, as continuous annular outlets and plates or as a mutually corresponding series of outlets and plates. The impact plates may be formed integrally with the sidewall of the vessel, for example as a thickening of the sidewall, or optionally may be attached thereto as well as being replaceable thereon.

Table I, below, is an exemplary listing of the process and sizing parameters for a syngas cooler to be used in small scale operation at moderate pressure, for example a pilot plant operating at a gas flow rate of 30,000 pounds/hour. The limiting heat transfer rate will be between the fluidized/moving bed solids and the water tube surface. These heat transfer rates are higher than for gas flow in the tube in a normal shell and tube heat exchanger, resulting in a compact heat transfer system design. The heat transfer coefficient used in this estimation is (55 Btu/(° F. hr ft²)).

TABLE I

| Process Item | Parameter | nit |
|---|---|---|
| Syngas | | |
| Hot Gas Flow Rate | 30000 | lb/hr |
| Gas Inlet Temperature | 1800 | ° F. |
| Design Gas Outlet Temperature | 1000 | ° F. |
| Design Gas Inlet Velocity | 70 | ft/s |
| Design Gas Outlet Velocity | 45 | ft/s |
| Gas Residence Time in the Riser | 0.5 | s |
| Operating Pressure | 235 | psia |
| Gas Pressure Drop in the Riser | 75 | in H₂O |
| Circulating Solids | | |
| Solids Return Temperature at the | 970 | ° F. |
| Inlet of the Riser | | |
| Solids Temperature at the Outlet of | 1000 | ° F. |
| the Riser | | |
| Solids Circulation Rate | 286 | lb/s |
| Solids Sealing Height | 20 | ft. |
| Solids Inventory in the standpipe | 12600 | lb |
| Solids to Gas Mass Flowrate Ratio | 34 | lb/lb |
| in the Riser | | |
| Heat Transfer Calculations | | |
| Heat Transfer Coefficient | 55 | BTU/(° F. · ft² · hr) |
| Heat Transfer Surface | 297 | ft² |
| Solids Retention Time | 44 | s |
| Water/Steam | | |
| Water inlet Temperature | 456 | ° F. |
| Sat. Steam Outlet Temperature | 456 | ° F. |
| Evaporation Rate | 11300 | lb/hr |
| Vessel Dimensions | | |
| Riser Inner Diameter (ID) | 9.33 | in |
| Riser Height | 23 | ft. |
| Outer Vessel ID | 2.78 | ft. |
| Outer Vessel OD | 4.11 | ft. |
| Outer Vessel Height | 33 | ft. |
| Aeration Gas | | |
| Gas Flow Rate | 972 | ft³/hr. |

Table II, below, is an exemplary listing of the process and sizing parameters of a gas treatment device of the types disclosed herein for use with a 300 MWe plant.

TABLE II

| Process Item | Parameter | Unit |
|---|---|---|
| Syngas | | |
| Hot Gas Flow Rate | 1,000,000 | lb/hr |
| Gas Inlet Temperature | 1,800 | ° F. |
| Design Gas Outlet Temperature | 1,000 | ° F. |
| Design Gas Inlet Velocity | 70 | ft/s |
| Design Gas Outlet Velocity | 45 | ft/s |
| Gas Residence Time | 0.5 | s |
| Operating Pressure | 415 | psia |
| Gas Pressure Drop | 75 | inH2O |
| Circulating Solids | | |
| Circulating Solids Return | 945 | ° F. |
| Temperature | | |
| Circulating Solids Outlet | 1000 | ° F. |
| Temperature | | |
| Circulating Solids Flow Rate | 2.78 | tons/s |
| Solids Column Height in Annular | 20 | ft |
| Section | | |
| Solids Inventory | 86 | tons |
| Solid to Gas Flow Rate Ratio | 19.4 | lb/lb |
| Heat Transfer Calculations | | |
| Heat Transfer Coefficient | 55 | BTU/(° F. ft² hr) |
| Heat Transfer Surface | 15900 | ft² |
| Solids Retention Time | 18 | s |
| Steam Side Parameters | | |
| Water Flow Rate | 315 | tons/hr |
| Water Inlet Temperature | 634 | ° F. |
| Sat. Steam Outlet Temperature | 634 | ° F. |
| Sat. Steam Pressure | 1980 | psia |
| Vessel Dimensions | | |
| Riser Inner Diameter (ID) | 41 | in |
| Riser Height | 23 | ft. |
| Outer Vessel ID | 11.43 | ft. |
| Outer Vessel OD | 12.9 | ft. |
| Outer vessel Height | 33 | ft. |
| Controlling Gas | 2000 | lbs/hr |
| Gas Flow Rate | | |

Although several embodiments of the invention have been disclosed in the foregoing specification, it is understood by those skilled in the art to which the invention pertains that many modifications and other embodiments of the invention will come to mind, having the benefit of the teaching presented in the foregoing description. Accordingly, it is understood that the invention is not limited to specific embodiments disclosed herein, and that many modifications and other embodiments of the invention are intended to be included in the scope hereof. Moreover, although specific terms are employed herein, they are used in the generic and descriptive sense only, and are not intended to limit the scope of the invention.

We claim:

1. A gas treatment device for treating a gas flow passed therethrough, the gas treatment device comprising:
a vessel formed about a longitudinal axis, the vessel having a first end, a spaced second end, and a continuous sidewall extending therebetween;
a gas chamber defined within the vessel;
an elongate gas riser passed into the vessel and into communication with the gas chamber;
a treatment particle bed defined within the vessel and in communication with the gas chamber, the particle bed being extended at least partially about the gas riser;
a flow control device in communication with the treatment particle bed and the gas riser; and
a treated gas discharge port in communication with the gas chamber.

2. The device of claim 1, further comprising a supply of gas treatment particles within the treatment particle bed, the flow control device being constructed and arranged to selectively pass therethrough at least some of the supply of gas treatment particles from the treatment particle bed into the gas riser so that the gas treatment particles passed into the gas riser are entrained and mixed with the gas flow passed therethrough and into the gas chamber.

3. The device of claim 2, further comprising at least one aeration nozzle in communication with the flow control device, and a supply of a pressurized fluid in communication with the at least one aeration nozzle and used to fluidize the gas treatment particles within the flow control device.

4. The device of claim 1, wherein the gas flow and the gas treatment particles are passed from the gas riser into the gas chamber, and the gas treatment particles fall out of the gas flow and into the treatment particle bed due to at least the force of gravity.

11. The device of claim 10, wherein the flow control valve comprises a valve housing having a first end and a spaced second end, a first side wall and a spaced second side wall, a third side wall and a spaced fourth side wall, the respective side walls being joined to one another along their common edges and extending between the respective first and second ends of the valve housing, the first and second side walls being at least partially tapered outwardly away from one another as they extend from the first end toward the second end of the valve housing.

12. The device of claim 11, wherein the flow control valve further comprises at least one aeration nozzle in communication with the valve housing for passing a pressurized fluid into the valve housing to selectively fluidize at least a portion of the gas treatment particles passed into the flow control device from the treatment particle bed.

13. The device of claim 11, wherein the valve housing has an entry port defined at the first end thereof for allowing the gas treatment particles passed into the flow control device to pass into the valve housing.

14. The device of claim 13, wherein the valve housing has an exit port defined in the third side wall and adjacent the second end of the valve housing for allowing the gas treatment particles passed into the entry port to pass from the valve housing.

15. The device of claim 14, wherein the gas flow treatment particles passed into the entry port flow within the valve housing toward the exit port when the aeration nozzle passes pressurized fluid into the valve housing.

16. The device of claim 1, further comprising a solids discharge port in communication with the treatment particle bed.

17. The device of claim 1, further comprising a solids inlet in communication with the gas chamber for introduction of gas treatment particles into the gas treatment device.

18. The device of claim 1, further comprising a first baffle positioned within the gas chamber spaced from and extended at least partially across the gas riser.

19. The device of claim 18, said first baffle further comprising an elongate sidewall extending along the periphery thereof and toward the treatment particle bed.

20. The device of claim 19, further comprising a second baffle positioned within the gas chamber and spaced from the first baffle.

21. The device of claim 20, said second baffle further comprising an elongate sidewall extending along the periphery thereof and toward the treatment particle bed, the sidewall of the second baffle being spaced about the sidewall of the first baffle.

22. The device of claim 21, wherein the sidewall of the second baffle is extended into the treatment particle bed.

23. The device of claim 22, further comprising at least one gas outlet defined within the sidewall of the second baffle.

24. The device of claim 23, further comprising a serpentine gas flow path defined by the first baffle and its sidewall, the second baffle and its sidewall, the treatment particle bed, and said at least one gas outlet.

25. The device of claim 23, further comprising at least one impact plate positioned on the vessel sidewall with respect to and spaced from said at least one gas outlet.

26. The device of claim 21, further comprising a series of radially spaced gas outlets defined within the sidewall of the second baffle.

27. A method of treating a gas flow, for example cooling or removing present contaminants therefrom, with gas treatment particles in a gas treatment device, the gas treatment device having a gas chamber defined within a vessel, a gas riser passed into communication with the gas chamber, a supply of gas treatment particles within a treatment particle bed, the treatment particle bed being in communication with the gas chamber, a flow control device in communication with the treatment particle bed and the gas riser, and a treated gas discharge port in communication with the gas chamber, the method comprising:
passing the gas flow to be treated through the gas riser and into the vessel;
using the flow control device to selectively pass at least some of the supply of gas treatment particles from the treatment particle bed into the gas riser such that the gas treatment particles passed into the gas riser are entrained and mixed with the gas flow;
treating the gas flow with the gas treatment particles;
passing the gas flow and the gas treatment particles into the gas chamber;
separating in the gas chamber the entrained gas treatment particles from the gas flow such that the gas treatment particles fall out of the gas flow;
passing the treated gas flow from the vessel through the gas discharge port; and,
collecting in the treatment particle bed the gas treatment particles that have fallen out of the gas flow.

28. The method of claim 27, the step of treating the gas flow comprising thermally treating the gas flow with the gas treatment particles.

29. The method of claim 27, wherein the step of treating the gas flow comprises cooling the gas flow with the gas treatment particles.

30. The method of claim 29, further comprising cooling the supply of gas treatment particles in the treatment particle bed.

31. The method of claim 27, wherein the step of treating the gas flow, comprises contacting the gas flow with the gas treatment particles such that the contaminants present within the gas flow are at least partially sorbed by the gas treatment particles.

32. The method of claim 27, wherein the step of using the flow control device to selectively pass at least some of the supply of gas treatment particles from the treatment particle bed into the gas riser comprises passing a pressurized fluid into the flow control device such that at least some of the gas treatment particles passed from the treatment particle bed into the gas riser are fluidized within the flow control device.

33. The method of claim 27, wherein the step of using the flow control device to selectively pass at least some of the supply of gas treatment particles from the treatment particle bed into the gas riser comprises passing at least some of the supply of gas treatment particles through a valve housing.

34. The method of claim 33, further comprising passing a pressurized fluid into the housing of the flow control device such that at least some of the gas treatment particles passed from the treatment particle bed into the gas riser are fluidized within the flow control device.

35. The method of claim 27, wherein the step of using the flow control device to selectively pass at least some of the supply of gas treatment particles from the treatment particle bed into the gas riser comprises:
passing at least some of the supply of gas treatment particles through a valve housing; and
passing a pressurized fluid into the valve housing such that at least some of the gas treatment particles passed through the valve housing are selectively fluidized and are passed into the gas riser.

36. The method of claim 27, further comprising the step of passing the gas flow from the gas riser toward a first baffle positioned within the vessel and extended at least partially across the gas riser, and directing the gas flow toward the treatment particle bed therewith.

37. The method of claim 36, further comprising the step of positioning a second baffle in the gas chamber spaced from the first baffle, and directing the gas flow away from the treatment particle bed with the second baffle toward at least one gas outlet defined within a sidewall of the second baffle.

38. The device of claim 37, comprising the step of extending said sidewall into the treatment particle bed.

39. The method of claim 38, further comprising the step of passing the gas flow from the gas riser through a serpentine gas flow path defined by the first baffle, the second baffle, the treatment particle bed, and said at least one gas outlet.

40. A flow control device for selectively passing particles from a particle bed having a supply of particles therein, the flow control device comprising:
a valve housing in communication with the particle bed, the valve housing having a first end and a spaced second end, a first side wall and a spaced second side wall, a third side wall and a spaced fourth side wall, the respective side walls being joined to one another along their common edges and extending between the respective first and second ends of the valve housing, the first and second side walls being at least partially tapered outwardly away from one another as they extend from the first end toward the second end of the valve housing.

41. The device of claim 40, wherein the valve housing is constructed and arranged to receive therein at least some of the particles from the particle bed, and to selectively fluidize at least a portion of the particles received therein so that the at least a portion of the particles received therein are passed from the valve housing.

42. The device of claim 41, being constructed and arranged such that the particles received by the valve housing from the particle bed are passed by at least the force of gravity from the particle bed into the flow control device.

43. The device of claim 41, further comprising:
at least one aeration nozzle in communication with the valve housing for passing a pressurized fluid into the valve housing used to selectively fluidize at least some of the particles received by the valve housing; and
a supply of a pressurized fluid in communication with the at least one aeration nozzle.

44. The device of claim 43, wherein the valve housing has an entry port defined at the first end of the valve housing for receiving therein the particles received by the valve housing.

45. The device of claim 44, wherein the valve housing has an exit port defined at the second end of the valve housing for passing therefrom the particles passed from the valve housing.

46. The device of claim 45, wherein at least a portion of the particles received by the valve housing flow upwardly within the valve housing from the entry port to the exit port and pass therefrom when the aeration nozzle passes the pressurized fluid into the valve housing.
